(19) United States
(12) Patent Application Publication
(10) Pub. No.: US 2024/0365747 A1
(43) Pub. Date: Nov. 7, 2024

(54) PLATFORM FOR A ROTARY MILKING PARLOR OF LIGHT-WEIGHT CONSTRUCTION AND CONTAINING CARBON CONCRETE

(71) Applicant: GEA Farm Technologies GmbH, Bönen (DE)

(72) Inventor: Karsten Schönrock, Herdecke (DE)

(21) Appl. No.: 18/565,731

(22) PCT Filed: May 25, 2022
(86) PCT No.: PCT/EP2022/064263

§ 371 Date: Nov. 30, 2023

(30) Foreign Application Priority Data
Jun. 18, 2021 (DE) 102021115841.9

(51) Int. Cl. A01K 1/12

(52) U.S. Cl. CPC A01K 1/126

(57) ABSTRACT

In order to increase the operational safety and service life of a rotary milking parlor (2), a rotatable annular platform (4), and drive and braking means for the platform (4) are proposed. The platform (4) has a plurality of milking stations (7) and the platform (4) rests on a carrier structure. According to the invention, the platform (4) is made of concrete and has a carbon reinforcement structure (17).

The invention relates to a rotary milking parlor comprising a rotatable platform having a plurality of milking stations.

Rotary milking parlors are used to milk milk-producing animals, especially cows. Handling large herds can be automated by means of a rotary milking parlor and in this way it can be performed with greater economic efficiency. Rotary milking parlors can be provided in many different embodiments. A rotary milking parlor can be designed as an external milker or an internal milker.

A rotary milking parlor comprises a platform in the form of an annular disk, on which the animals to be milked stand during the milking process. Mechanical components and a support structure are arranged below the platform. The rotary milking parlor furthermore comprises driving and braking means in order to control the rotation of the platform. The power of the driving and braking means must be designed for the loads which arise on account of starting up, accelerating and/or braking.

Rotation takes place by way of a rail system. All of the components must be designed to be sufficiently robust to withstand the dead weight of the platform, the weight of the animals to be milked, and the dynamic loads that result from the acceleration and braking processes.

The rail system comprises a guide track connected to the platform. A static supporting track is installed as a counterpart on supporting pedestals. The supporting pedestals for their part are cast into a foundation. Between the supporting track and the guide track there is a supporting carriage, which comprises a multiplicity of rollers. The supporting track and the guide track are situated concentrically one above the other and are mounted in such a way that movements in the radial direction are very largely prevented.

The novel platform described here is intended to make a contribution to the process of optimizing the rotary milking parlor. In particular, a rotary milking parlor with a longer service life is specified.

According to the invention, this object is achieved by means of a rotary milking parlor having the features of claim 1. Particularly advantageous embodiments, to which however the invention is not restricted, are explained in greater detail below.

The rotary milking parlor according to the invention has a rotatable platform in the form of an annular disk. Driving and braking means are provided for the platform. The platform has a plurality of milking stations. The platform rests on a support structure. This platform is made of concrete and has a carbon reinforcement. The concrete and the carbon reinforcement together form a composite material.

The use of concrete as a component of the composite material is tried and tested since it is advantageous, rough and robust. The rough surface, in particular, is advantageous. If other materials were used, it might be necessary to generate a rough surface retrospectively to ensure that the animals had secure footing despite the rotation of the platform, acceleration and braking effects, and the possibly damp surface.

The platform of comparable rotary milking parlors is conventionally produced from steel-reinforced concrete. Owing to the spatial extent of such a platform, it is customary to cast the platform in situ. Extensive accompanying work is required for this purpose. Formwork must be installed for casting. Moreover, the in situ concrete can take several days to set. The reinforcement consisting of steel elements is economical but involves a high dead weight.

The rotary milking parlor according to the invention is distinguished, in particular, by the fact that the platform has a carbon reinforcement. Carbon has a low density and is therefore light. Moreover, carbon has advantages in terms of its material properties since it is characterized by a high tensile and compressive strength. The provision of a carbon reinforcement is preferred in view of a high strength and simultaneous weight saving.

All the loadbearing elements as well as the driving and braking means are relieved of load by the reduction in the weight of the platform. Thus, acceleration and braking processes can be carried out more quickly and with less stress on the materials. The load imposed by the novel platform on the supporting carriage comprising each individual one of its rollers and the rail system is reduced, and this has an advantageous effect with regard to increasing the service life.

The invention thus represents an improvement in many respects. Particularly in an emergency which requires the immediate halting of the platform, the lighter platform can be brought to a halt more quickly, and therefore operation can be regarded as safer overall. Reliable, quick and low-wear braking of the platform can advantageously be achieved by a reduction in the weight of the platform.

In addition, there are many technical and economic advantages. Among those that may be mentioned are a reduced energy requirement for acceleration and braking of the platform.

If the platform has to be halted for cleaning, maintenance or other operational reasons, operation can furthermore be stopped and resumed more quickly.

Another advantageous characteristic of the platform containing carbon is that it is insensitive to moisture and virtually maintenance-free. The platform can be exposed to an aggressive environment. Both excretions by animals to be milked and various cleaning agents and disinfectants come into contact with the platform and promote potential corrosion of a reinforcement. When the reinforcement is made of carbon, there is no need for inspections and local repairs of the platform. The inherent freedom from corrosion of carbon ensures a further increase in the service life of the platform.

In the case of platforms made of steel-reinforced concrete, it is customary to apply a top layer of concrete with a thickness of several centimeters above the reinforcement in order to protect it from corrosion. This requirement is eliminated when the reinforcement is made of carbon, and there is the advantage of a further reduction in weight.

Among the factors relevant to the service life of the rotary milking parlor are the driving and braking means and their susceptibility to wear. These must be designed in such a way that they can withstand the loads that are to be expected during operation of the rotary milking parlor. In the rotary milking parlor according to the invention, the driving and braking means are operated under lower loads, and therefore a longer service life of the driving and braking means is achieved. Owing to the reduction in the mass of the platform, lower forces act on all the loadbearing elements, and therefore the service life of the rotary milking parlor per se is increased.

Overall, the embodiment according to the invention of the rotary milking parlor also leads to an acceleration of the operating sequences, an increase in safety and a reduction in maintenance costs.

The platform of the rotary milking parlor according to the invention can comprise a variable number of segments which, overall, form an annular disk. These can be arranged so as to abut one another. Rapid and simple construction of the platform can thereby be achieved. In this case, the segments can already be provided as semifinished or finished parts for the construction of the platform.

A frame-type supporting structure consisting of an internal and external ring, which are connected, is suitable as an aid and as a support structure for the assembled segments. The connection can be made by radially arranged station spokes. The segments can be positioned on the station spokes and connected to them.

Alternatively and/or additionally, the support structure can be formed without station spokes. The station spokes can also be contained in the segments and connected to the support structure.

The segments can also be connected to one another by means of coupling elements. The joining of the segments can be accomplished, for example, by means of coupling elements which are contained in the segments and are connected to one another in situ. A segment can contain a groove in the edge region. The segments can be designed in such a way that edge regions of adjacent segments overlap and/or engage in one another. The connection is preferably flush and so tight that the gaps between the segments are as small as possible. If necessary, the gaps should additionally be sealed.

A continuous surface above the segments has the advantage that the components of the rotary milking parlor which are situated below the platform and, in particular, the driving and braking means are protected from the environment, which is by its very nature aggressive, and cleaning work is made easier. According to another advantageous embodiment of the rotary milking parlor according to the invention, a continuous surface of the platform can be achieved by providing the segments with a top layer situated above them. This can be designed as a layer of in situ concrete. A top layer of in situ concrete can also be used to seal the gaps between the segments. The in situ concrete can be cast in a significantly shorter time, thus avoiding problems with premature setting of the concrete. This is relevant especially for seamless joining of the concrete ring.

The semifinished construction comprising the segments in combination with a layer of in situ concrete makes it possible to reduce assembly times. Since less in situ concrete is cast overall, drying times are shortened, and various accompanying work for complete in situ concrete casting is eliminated.

The reinforcement of the platform can be partially or fully contained in the segments. The invention is not limited to a particular way of embodying the reinforcement. The reinforcement can project from the segments. If there is a top layer, it is possible, according to an advantageous embodiment, for the reinforcement to project into the top layer in order simultaneously to serve as a reinforcement for the top layer.

As regards the quantity and design of the reinforcement, e.g. with carbon bars, prefabricated non-crimp carbon fabrics or other reinforcing elements containing carbon, variations are possible. In particular, it is possible to implement an adaptation of the embodiment of the reinforcement which takes account of the intended use of the rotary milking parlor. The number of standing positions and the type of animal to be milked or an average mass of the animals are parameters which influence the diameter and the expected load on the rotary milking parlor. Consistent with this, a load-dependent embodiment of the reinforcement is worthwhile.

In preferred embodiments of the invention, the formwork required for the in situ concrete casting can be provided in part by the design of the segments. Barriers can be integrated into the segments. The edge regions of the segments can be of bead-type design in the circumferential direction. As an alternative or in addition, the formwork can be provided by inserts applied to the edges of the segments.

Moreover, there is the possibility of integrating different devices into the segments to enable the rotary milking parlor to be embodied in a variable manner. Devices for fastening separating elements for subdividing the milking stations, devices for feeding troughs or drinking troughs, pipe lead-throughs and further details for the configuration of the platform are possible.

According to another exemplary embodiment, a segment can be designed in such a way that it has a station spoke as an integral component. The station spoke and thus the segment comprising the station spoke can then be connected to the support structure on site. This creates the opportunity to reduce the assembly effort.

It is possible to provide a rotary milking parlor according to the invention as such. In addition, there is the possibility of equipping rotary milking parlors that are already in operation with a new platform of a rotary milking parlor according to the invention. Retrofitting a carbon-reinforced platform can also be economically advantageous since rapid amortization of investment can be expected from the considerable reduction in operating costs and the increase in the life expectancy of the rotary milking parlor.

The invention and the technical environment are explained in greater detail below by means of the figures. The figures show particularly preferred exemplary embodiments, although the invention is not restricted thereto. More specifically:

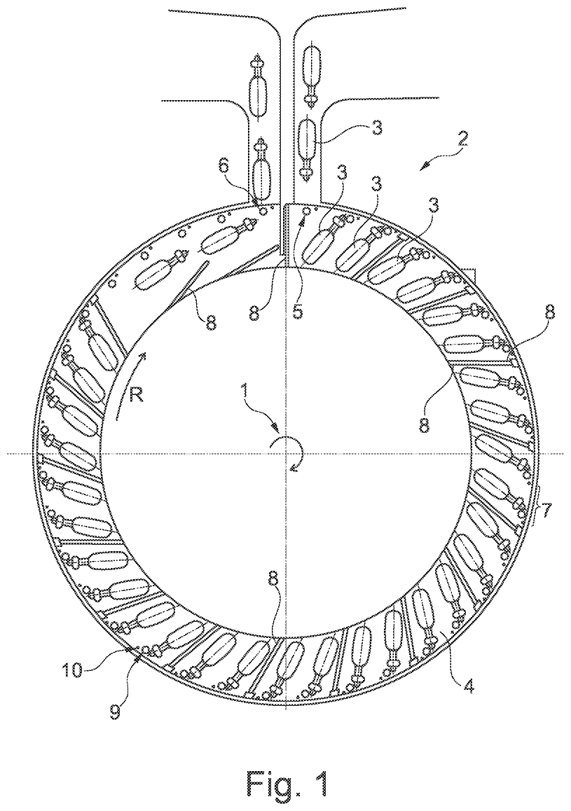

FIG. 1 shows a plan view of a rotary milking parlor,

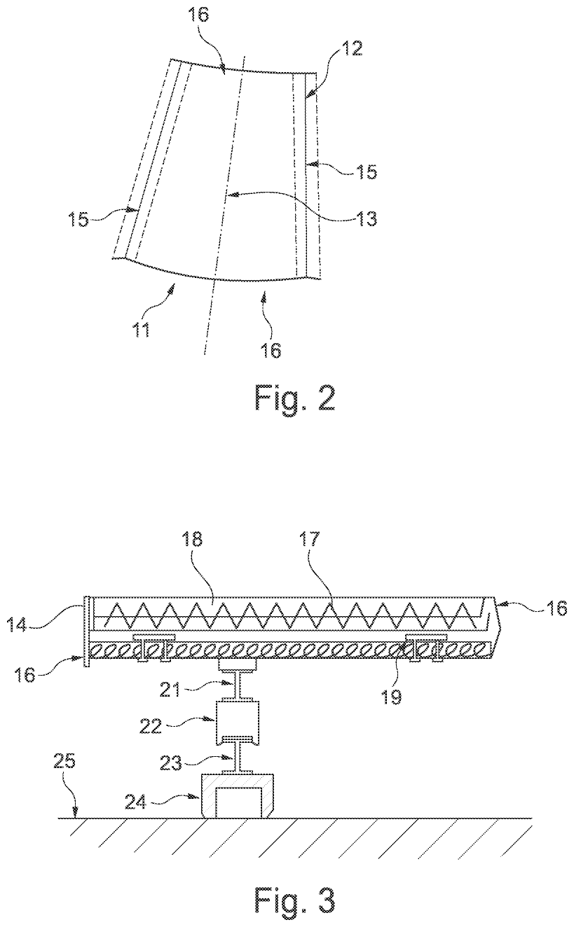

FIG. 2 shows a schematic plan view of a segment of a platform,

FIG. 3 shows a schematic cross section of a rotary milking parlor, and

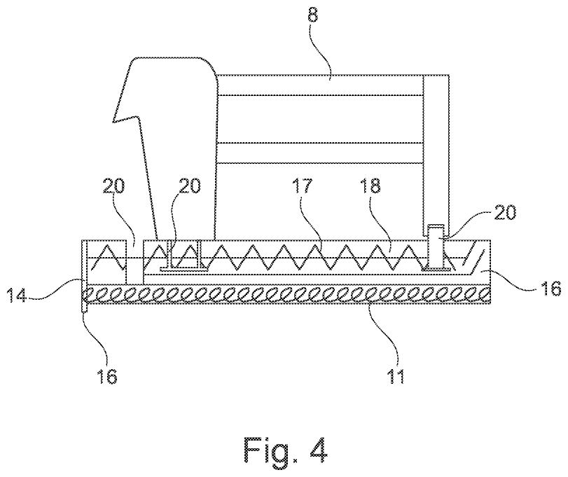

FIG. 4 shows another schematic cross section of a rotary milking parlor.

FIG. 1 shows a plan view of a rotary milking parlor 2. In addition to the devices required for the milking process, which are not illustrated here, this comprises a platform 4. It rests on a support structure, which is likewise not illustrated in FIG. 1. Below the platform 4 there are additional technical components, which allow rotation of the platform 4 in the direction of rotation R about an axis of rotation 1.

During all the processes described below, the platform 4 is rotated continuously. The animals 3 stand radially with respect to the platform 4 in the form of an annular disk during the milking process. The rotary milking parlor 2 can either be configured in such a way, as illustrated here, that the milking units are situated on the inside and the animals 3 look outward or vice versa.

The animals 3 to be milked, which can be cows for example, mount the platform 4 in the region of the entry 5. During the milking process, the animals 3 stand on the platform 4. The platform 4 is divided into a plurality of milking stations 7. Milking units are installed at each milking station 7. The platform 4 is subdivided by separating elements 8. A separating element 8 can be formed by different elements, comprising bars, plates or other parts. Variants of the platform 4 with more than one milking station 7 between two separating elements 8 are possible. Depending on the embodiment of the rotary milking parlor 2, there can be the possibility for the animal 3 to take on nutrition at feeding troughs 9 or drinking troughs 10 during the milking process.

The milking process is generally complete before a milking station 7 has been rotated from the entry 5 to the exit 6, i.e. by almost 360°. As soon as the milking station 7 reaches the exit 6, the animal 3 can leave the platform 4 in the region of the exit 6.

To enable the animal 3 to leave the platform 4 in a convenient way, the separating elements 8 can preferably be configured in such a way that, according to the embodiment shown here, they are rotatably mounted and gradually pivot open before the exit 6 is reached. This enables the animal 3 to turn comfortably. Variants, e.g. in the form of more generously dimensioned milking stations 7 or larger gaps between two separating elements 8, which make it superfluous to pivot open the separating elements 8, are conceivable.

FIG. 2 shows a schematic plan view of a single segment 11 of the platform 4. A segment 11 can be designed as a semifinished or finished concrete component. A segment 11 has two longitudinal regions 15 and respective outer and inner arc-shaped end regions 16. The longitudinal regions 15 of a segment 11 extend over the edge of the segment 11 in the radial direction. A central radial axis 13 of a segment 11 can be regarded as an axis of symmetry.

The platform 4 is in the form of an annular disk and comprises a plurality of segments 11. Below the segments 11 is a support structure, which is not fully illustrated. This comprises an inner and an outer ring and a plurality of radial station spokes 12 to connect the rings. The imaginary horizontal extensions of all the station spokes 12 intersect at the same point on the axis of rotation 1.

The segments 11 are held by the support structure and, in particular, rest on the station spokes 12. In this case, two adjacent segments 11 can be positioned in such a way that the respective longitudinal region 15 of adjacent segments 11 rests on the station spokes 12 of the support structure. As an alternative, it is possible to position the segments 11 in such a way that a central radial axis 13 of a segment 11 rests on the station spokes 12. In both of the variants presented, the number of station spokes 12 and segments 11 must correspond, and the station spokes 12 must be equidistantly distributed.

According to another possible embodiment, there can be twice as many station spokes 12 as segments 11, with the result that there is a station spoke 12 both underneath the longitudinal regions 15 of two adjacent segments 11 and also below the central radial axis 13 of a segment 11.

FIG. 3 shows a schematic cross section of the rotary milking parlor 2. Inter alia, it comprises illustrations of a segment 11 and of a top layer 18 situated above the latter, which together form the platform 4. The top layer 18 can preferably be a continuous concrete cover, which can be cast from in situ concrete. Underneath the platform 4, the rotary milking parlor 2 comprises a plurality of elements, on which the platform 4 is mounted and with the aid of which the platform 4 can be rotated.

The platform 4 comprises a plurality of segments 11. Possible embodiments of a segment 11 can be seen in the cross section. FIG. 3 shows two variants, in which a segment 11 can be formed. The segments 11 as a whole serve as a base for the platform 4 and can furthermore be used as a mold for casting a top layer 18 from in situ concrete.

An insert 14 can be connected in a suitable manner to the segment 11. This can be of T-shaped design and can project to the extent required, depending on the desired thickness of the top layer 18. Alternatively or in addition, a segment 11 can be configured in such a way that it is higher in the circumferential direction in the edge regions 15 and/or the end regions 16 and is thus of trough-type design. The aim of both alternatives is to prevent the in situ concrete from flowing down the sides.

The segment 11 has a reinforcement 17. The reinforcement 17 is preferably provided by means of carbon elements and can be in the form of inserted lattice bars or prefabricated meshes. The reinforcement 17 can project out of the segment 11 and into the top layer 18 in such a way that it also contributes to an increase in the strength of the top layer 18.

Assembly components 19 can be provided for the purpose of fastening the platform 4 on the support structure. These serve as connecting elements between the segment 11 and the station spoke 12 and can be cast into the segment 11 as inserts, for example.

The platform 4 is moved together with a guide track 21 on a stationary supporting track 23 by means of a supporting carriage 22. The supporting track 23 and the guide track 21 are each in the form of an annular rail. While the guide track 21 is connected to the platform 4, the supporting track 23 is mounted on supporting pedestals 24. The supporting pedestals 24 are preferably cast into a foundation 25 equidistantly along an imaginary circular track underneath the platform 4.

The supporting track 23 and the guide track 21 have the same diameter and are situated concentrically one above the other. The interposed supporting carriage 22 can be made up of component parts, each having one or more rollers, and enables the platform 4 to be moved around the axis of rotation 1. The driving and braking system for moving the platform 4 is not illustrated.

FIG. 4 illustrates a schematic detail view of a segment 11 according to FIG. 2 in cross section.

In addition to the insert 14 and the edge region 15 intended to demonstrate the lateral boundary for in situ concrete casting, the exemplary embodiment shown here comprises various connecting means 20. These connecting means 20, which are implemented as inserts for example, can be provided for the purpose of fastening the separating elements 8 or as a leadthrough device for pipes, cables or hoses, or as a drainage means. The list of additional components as connecting means 20 of various embodiments and for various purposes, e.g. for fastening feeding troughs 9 or drinking troughs 10, can be extended as desired.

### LIST OF REFERENCE SIGNS

1 axis of rotation
2 rotary milking parlor
3 animal
4 platform
5 entry
6 exit
7 milking station
8 separating element
9 feeding trough
10 drinking trough
11 segment
12 station spoke
13 central radial axis
14 insert
15 longitudinal region
16 end region
17 reinforcement
18 top layer
19 assembly component
20 connecting means
21 guide track
22 supporting carriage
23 supporting track
24 supporting pedestal
25 foundation
R direction of rotation

1. A rotary milking parlor, comprising
a rotatable platform in the form of an annular disk, and
a driving and braking system for the platform,
wherein the platform has a plurality of milking stations, rests on a support structure,
is made of concrete and
has a carbon reinforcement.

2. The rotary milking parlor as claimed in claim 1, wherein the platform is made up of segments.

3. The rotary milking parlor as claimed in claim 2, wherein the support structure has radially arranged station spokes below the platform.

4. The rotary milking parlor as claimed in claim 2, wherein the segments contain coupling elements, which are used for interlinking the segments.

5. The rotary milking parlor as claimed in claim 1, wherein the platform has a top layer.

6. The rotary milking parlor as claimed in claim 5, wherein the reinforcement projects into the top layer.

7. The rotary milking parlor as claimed in claim 1, wherein the reinforcement is formed from carbon bars, non-crimp carbon fabrics or other carbon-containing reinforcing elements.

8. The rotary milking parlor as claimed in claim 2, wherein the segments contain a barrier in a circumferential direction in inner and outer edge regions of the segments.

9. The rotary milking parlor as claimed in claim 8, wherein the barrier is formed by inserts.

10. The rotary milking parlor as claimed in claim 2, wherein the segments comprise devices for fastening separating elements, feeding troughs, and/or drinking troughs.

11. The rotary milking parlor as claimed in claim 1, wherein a station spoke is an integral part of a segment, and the station spoke is connected to the support structure.
